(19) United States
(12) Patent Application Publication
(10) Pub. No.: US 2008/0145203 A1
(43) Pub. Date: Jun. 19, 2008

(54) METHOD OF TRANSFERRING TEST TRAYS IN A HANDLER

(76) Inventors: Hyo-chul YUN, Seoul (KR); Hee-rak Beom, Seoul (KR); Jae-myeong Song, Seongnam-si (KR); Yong-geun Park, Yongin-si (KR); Dae-gon Yun, Gumi-si (KR)

Correspondence Address: KED & ASSOCIATES, LLP, P.O. Box 221200, Chantilly, VA, 20153-1200, US

(21) Appl. No.: 11/943,855

(22) Filed: Nov. 21, 2007

(30) Foreign Application Priority Data
Nov. 22, 2006 (KR) 10-2006-0115697
Nov. 22, 2006 (KR) 10-2006-0115699
Nov. 22, 2006 (KR) 10-2006-0115700
Nov. 22, 2006 (KR) 10-2006-0115701

(51) Int. Cl. B65G 47/74; B65G 69/26

(52) U.S. Cl. 414/804; 414/806

(57) ABSTRACT

Provided is a method for transferring test trays in a handler including a second chamber having two test sites arranged in parallel, a first chamber having a plurality of passages along which a plurality of test trays are horizontally moved, provided over the second chamber, and a third chamber having a plurality of passages along which the plurality of test trays are horizontally moved, provided under the second chamber, the method including steps of (a) enabling two test trays to wait in parallel in a horizontal position at a waiting location provided to a forward section of the handler, (b) loading packaged chips onto the two test trays, (c) rotating the two test trays to be in the upright position, (d) moving upwards the two test trays into the first chamber, (e) heating or cooling the two test trays while moving horizontally the two test trays forward in the first chamber, (f) moving downward the two test trays from the first chamber into the second chamber, (g) moving horizontally the two test trays toward two test boards provided in the second chamber, the two test boards opposite to the handler and thus enabling the two test trays to contact the two test boards to test the packaged chips contained the two test trays, (h) moving downwards the two test trays from the second chamber into the third chamber and allowing the two test trays to be cooled or heated to room temperature while moving forwards the two test trays in the third chamber, (i) moving upwards the two test trays from the third chamber to the waiting location, (j) rotating the two test trays to be in the horizontal position; and (k) unloading the packaged chips from the two test trays.

### CROSS REFERENCE TO RELATED APPLICATIONS

This application claims priority from Korean Patent Application Nos. 10-2006-0115697, 10-2006-0115699, 10-2006-0115700 and 10-2006-0115701, all filed on Nov. 22, 2006, the disclosures of which are incorporated herein in their entireties by reference.

### BACKGROUND OF THE INVENTION

1. Field of the Invention

The present invention relates to a method for transferring test trays in a handler handling a packaged chip for an electrical test.

2. Description of the Related Art

At the conclusion of a packaging process, a handler puts packaged chips through a series of environmental, electrical, and reliability tests. These tests vary in type and specifications, depending on the customer and use of the packaged devices. The tests may be performed on all of the packages in a lot or on selected samples.

The handler puts packaged chips into a test tray and supplies the test tray to a tester. The tester includes a test board with a plurality of sockets, performing an electrical test on the packaged chips. The packaged chips are inserted into the sockets of the test board for the electrical test. The handler puts the packaged chips into a test tray, i.e. a jig and inserting the packaged chips contained in a test tray into sockets of the test board. The handler sorts the packaged chips according to a test result. The handler removes packaged chips from a user tray and put the removed packaged chips into sockets of the test tray. The handler transfers the test tray to the tester. (This is referred as to “a loading operation”. The handler removes tested packaged chips from the sockets of the test tray and the tested packaged chips to a user tray (This is referred as to “an unloading operation”)

The handler includes a loading stacker where the user trays are stacked, a unloading stacker where the user trays are stacked each of which are to contain the tested packaged chips according to a test result, an exchanging site where a test tray containing to-be-tested packaged chips stays before being transferred to the tester, a loading picker transferring the to-be-tested packaged chips from the loading stacker to the test tray, and an unloading picker transferring the tested packaged chips from the test tray to the unloading stacker.

The loading picker picks up the to-be-packaged chip from the loading stacker to place it to the test tray staying at the exchanging site. The test tray containing the to-be-tested packaged chips is transferred to the tester. The test tray, after the packaged chips are tested, is transferred to an unloading unit. The unloading picker picks up the tested packaged chip from the test tray to transfer it to the unloading stacker. At this point, the tested packaged chip is placed into corresponding user tray, according to the test result.

The handler includes a test unit 150 which tests the packaged chips for an electrical test at extremely low and high temperature, as well as at room temperature. The test unit includes a heating (or cooling) chamber, a test chamber, and a cooling (or heating) chamber.

The test tray containing the packaged chips is transferred from the exchanging site to the heating or cooling chamber. In the heating or cooling chamber, the packaged chips are heated or cooled to extremely high or low temperature. Then the test tray containing the extremely high-heated or cooled packaged chips is transferred to the test chamber. In the test chamber, the test tray containing the extremely high-heated or cooled packaged chips gets in contact with a test board in the tester which is provided opposite to the handler, resulting in the extremely high-heated or cooled packaged chips being tested. Thereafter, the test tray is transferred to the cooling or hearting chamber, to cool or heat the extremely high-heated or cooled packaged chips to room temperature.

However, in a conventional handler, a single test tray containing the packaged chips passes through the heating (or cooling) chamber, the test chamber, and the cooling (or heating) chamber, in this order. This limits a quantity of packaged chips which are tested at a time and in a given time.

### SUMMARY OF THE INVENTION

Therefore, an object of the present invention is to transfer test trays in a handler to increase a quantity of packaged chips which are tested at a time and in a given time.

According to an aspect of the present invention, there is provided A method for transferring test trays in a handler comprising a second chamber having two test sites arranged in parallel, a first chamber having a plurality of passages along which a plurality of test trays are horizontally moved, provided over the second chamber, and a third chamber having a plurality of passages along which the plurality of test trays are horizontally moved, provided under the second chamber, the method including steps of (a) enabling two test trays to wait in parallel in a horizontal position at a waiting location provided to a forward section of the handler, (b) loading packaged chips onto the two test trays, (c) rotating the two test trays to be in the upright position, (d) moving upwards the two test trays into the first chamber, (e) heating or cooling the two test trays while moving horizontally the two test trays forward in the first chamber, (f) moving downward the two test trays from the first chamber into the second chamber, (g) moving horizontally the two test trays toward two test boards provided in the second chamber, the two test boards opposite to the handler and thus enabling the two test trays to contact the two test boards to test the packaged chips contained the two test trays, (h) moving downwards the two test trays from the second chamber into the third chamber and allowing the two test trays to be cooled or heated to room temperature while moving forwards the two test trays in the third chamber, (i) moving upwards the two test trays from the third chamber to the waiting location, (j) rotating the two test trays to be in the horizontal position; and (k) unloading the packaged chips from the two test trays.

According to another aspect of the present invention, there is provided a method for transferring test trays in a handler comprising a second chamber having two test sites arranged in parallel, a first chamber having a plurality of passages along which a plurality of test trays are horizontally moved, provided under the second chamber, and a third chamber having a plurality of passages along which the plurality of test trays are horizontally moved, provided over the second chamber, the method including steps of (a) enabling two test trays to wait in parallel in a horizontal position at a waiting location provided to a forward section of the handler, (b) loading packaged chips onto the two test trays, (c) rotating the two test trays to be in the upright position, (d) moving downwards the two test trays into the first chamber, (e) heating or cooling the two test trays while moving horizontally the two test trays forward in the first chamber, (f) moving upwards two test trays from the first chamber into the second chamber, (g) moving horizontally the two test trays toward two test boards provided in the second chamber, the two of test boards opposite to the handler and thus enabling the two test trays to contact the two test boards to test the packaged chips contained the two test trays, (h) moving upwards the two test trays from the second chamber into the third chamber, and allowing the two test trays to be cooled or heated to room temperature while moving forwards the two test trays in the third chamber, (i) moving downwards the two test trays from the third chamber to the waiting location, (j) rotating the two test trays to be in the horizontal position; and (k) unloading the packaged chips from the two test trays.

According to another aspect of the present invention, there is provided a method for transferring test trays in a handler comprising a second chamber having four test sites arranged in two rows and two columns, a first chamber having a plurality of passages along which a plurality of test trays are horizontally moved, provided over the second chamber, and a third chamber having a plurality of passages along which the plurality of test trays are horizontally moved, provided under the second chamber, the method including steps of (a) enabling two test trays to wait in parallel in a horizontal position at a waiting location provided to a forward section of the handler, (b) loading packaged chips onto the two test trays, (c) rotating the two test trays to be in the upright position, (d) moving upwards the two test trays into the first chamber, (e) heating or cooling the two test trays while moving horizontally the two test trays forward in the first chamber, (f) moving downwards the two test trays from the first chamber and placing the two test trays at the lower two test sites of the second chamber, (g) moving downwards the next test trays from the first chamber and placing the two trays at the upper two test sites of the second chamber, (h) moving horizontally the four test trays toward four test boards provided in the second chamber, the four test boards opposite to the handler and thus enabling the four test trays to contact the four test boards to test the packaged chips contained the four test trays, (i) moving downwards the two test trays from the second chamber into the third chamber, and allowing the two test trays to be cooled or heated to room temperature while moving forwards the two test trays in the third chamber, (j) moving upwards the two test trays from the third chamber to the waiting location, (k) rotating the two test trays to be in the horizontal position; and (l) unloading the packaged chips from the two test trays.

According to another aspect of the present invention, there is provided a method for transferring test trays in a handler comprising a second chamber having four test sites arranged in a rows, a first chamber having a plurality of passages along which a plurality of test trays are horizontally moved, provided over the second chamber, and a third chamber having a plurality of passages along which the plurality of test trays are horizontally moved, provided under the second chamber, the method including steps of (a) enabling two test trays to wait in parallel in a horizontal position at a waiting location provided to a forward section of the handler, (b) loading packaged chips onto the two test trays, (c) rotating the two test trays to be in the upright position, (d) moving upwards the two test trays into the first chamber, (e) moving horizontally the two test trays and moving upwards the next two test trays into the first chamber, resulting in the four test trays being placed in a row, (f) heating or cooling the four test trays while moving horizontally the four test trays forward in the first chamber, (g) moving downwards the four test trays from the first chamber into the test chamber, (h) moving horizontally the four test trays toward four test boards provided in the second chamber, the four test boards opposite to the handler and thus enabling the four test trays to contact the four test boards to test the packaged chips contained the four test trays, (i) moving downwards the four test trays from the second chamber into the third chamber, and allowing the four test trays to be cooled or heated to room temperature while moving forwards the four test trays in the third chamber, (j) moving upwards the two test trays out of the four test trays from the third chamber to the waiting location, (k) rotating the two test trays to be in the horizontal position, (l) unloading the packaged chips from the two test trays.

(m) moving horizontally the remaining two test trays in the third chamber, moving upwards the remaining two test trays from the third chamber to the waiting location, and rotating the remaining two test trays to be in the horizontal position; and (n) rotating the remaining two test trays to be in the horizontal position.

According to another aspect of the present invention, there is provided A method for transferring test trays in a handler comprising a second chamber having four test sites arranged in two rows and two columns, two first chambers, and two third chambers wherein one first chamber and one third chamber are arranged adjacent to one side of the second chamber and the other first chamber and the other third chamber are arranged adjacent to the other side of the second chamber, the method including steps of (a) enabling two test trays to wait in parallel in a horizontal position at a waiting location provided to a forward section of the handler, (b) loading packaged chips onto the two test trays, (c) rotating the two test trays to be in the upright position, (d) moving horizontally the two test trays from the waiting location into the first chambers, respectively, (e) moving horizontally the two test trays forwards in the first chambers, respectively, (f) moving the four test trays in pairs from the first chambers into the second chamber having four test sites arranged in two row and two columns, (g) moving horizontally the four test trays placed at the four sites toward four test board opposite to the handler, (h) moving the four test trays from the second chamber into the third chambers and cooling or heating the four test trays to room temperature while moving horizontally the four test trays forward in the third chambers, (i) moving the two test trays, one from each of the third chambers, from the third chambers to the waiting location, (j) rotating the two test trays to be in the upright position at the waiting location; and (k) unloading the packaged chips from the two test trays.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates a top view of a handler in which to use a method for transferring test trays according to a first embodiment of the present invention;

FIG. 2 illustrates a rear view of a test unit which is shown in FIG. 1;

FIG. 3 illustrates a perspective view of the test of FIG. 2 which helps explaining about a passage along which the test tray is moved when using the method for transferring test trays according to the first embodiment of the present invention;

FIG. 4 illustrates a rear view of another test unit which is shown in FIG. 1;

FIG. 5 illustrates a perspective view of the test of FIG. 4 which helps explaining about a passage along which the test tray is moved when using a method for transferring test trays according to a second embodiment of the present invention;

FIG. 6 illustrates a rear view of another test unit which is shown in FIG. 1;

FIG. 7 illustrates a perspective view of the test of FIG. 6 which helps explaining about a passage along which the test tray is moved when using a method for transferring test trays according to a third embodiment of the present invention;

FIG. 8 illustrates a rear view of another test unit which is shown in FIG. 1;

FIG. 9 illustrates a perspective view of the test of FIG. 8 which helps explaining about a passage along which the test tray is moved when using a method for transferring test trays according to a fourth embodiment of the present invention;

FIG. 10 illustrates a perspective view of the test of FIG. 8 which helps explaining about a path which the test tray follows when using a method for transferring test trays according to a fifth embodiment of the present invention;

FIG. 11 illustrates a rear view of another test unit which is shown in FIG. 1;

FIG. 12 illustrates a perspective view of the test of FIG. 11 which helps explaining about a passage along which the test tray is moved when using a method for transferring test trays according to a sixth embodiment of the present invention;

FIG. 13 illustrates a rear view of another test unit which is shown in FIG. 1; and

FIG. 14 illustrates a perspective view of the test of FIG. 13 which helps explaining about a passage along which the test tray is moved when using a method for transferring test trays according to a seventh embodiment of the present invention;

### DETAILED DESCRIPTION OF EXEMPLARY EMBODIMENTS

Reference will now be made in detail to the preferred embodiments of the present invention, examples of which are illustrated in the accompanying drawings.

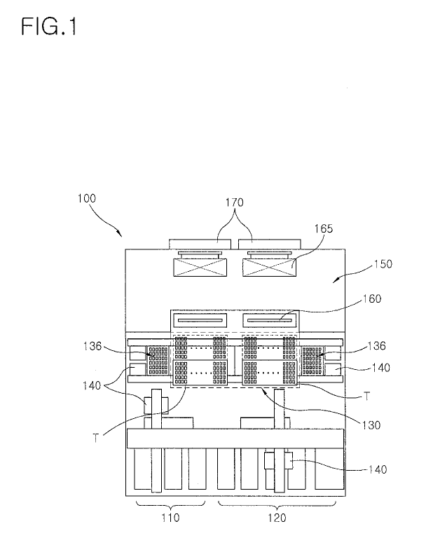

FIG. 1 illustrates a top view of a handler in which to use a method for transferring test trays according to a first embodiment of the present invention.

As shown in FIG. 1. a handler 100 includes a loading stacker 110 where the user trays are stacked, a unloading stacker 120 where the user trays are stacked each of which are to contain the tested packaged chips according to a test result, an exchanging site 130 where a test tray containing to-be-tested packaged chips stays before being transferred to the tester, a loading picker transferring the to-be-tested packaged chips from the loading stacker to the test tray, and an unloading picker transferring the tested packaged chips from the test tray to the unloading stacker.

The loading stacker 110 is provided in a forward section of the handler 100. User trays, each containing to-be-tested packaged chips, are stacked in the loading stacker 110. The unloading stacker 120 and the loading stacker 110 are provided in parallel adjacent to each other. The user trays are placed In the unloading stacker 120. An identification mark, indicating a grade of a packaged chip, is assigned to each of user trays. The tested packaged chips, after tested, are sorted according to grade and are contained in the corresponding user tray.

The exchanging site 130, as shown in FIG. 1, is provided in the rear of the loading stacker 110 and the unloading stacker 120. Test trays T are placed in a pair in the exchanging site 130, according to the first embodiment of the present invention.

In the exchanging site 130, a to-be-tested packaged chip is loaded onto the test tray T and a tested packaged chip is unloaded from the test tray T. The to-be-tested packaged chip is transferred by the loading picker from the loading stacker 110 to the test tray T. The tested packaged chip is transferred by the unloading picker from the test tray T to the unloading stacker 120.

A driving unit, moving the test tray T backwards and forwards, may be provided in the exchanging site 130. Buffer units 136, where packaged chips temporarily stay, may be provided adjacent to both lateral sides of the exchanging site, respectively.

Pickers 140 make round trips between the loading stacker 110, the buffer unit 136, the exchanging site 130, and the unloading stacker 120, to transfer the packaged clip. The picker 140 picks up and places the packaged chip from and to the test tray T.

The test unit 150 is provided in the rear of the exchanging site 130. The test unit 150 receives the test tray T containing the packaged chips from the exchanging site 130 and tests the packaged chips for specific parameters, at extremely low and high temperature, as well as at room temperature.

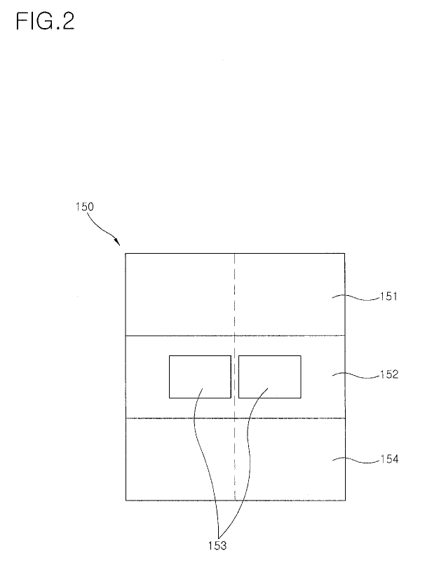

The test unit 150 includes a first chamber 151, a second chamber 152, and a third chamber 154, as shown in FIG. 2, to perform the test on the packaged chips.

In the first chamber 151, the packaged chips, contained in the test tray T which is transferred from the exchanging site 139, are heated to extremely high temperature or cooled to extremely low temperature. In the second chamber 152, extremely-high-heated or extremely-low-cooled packaged chips contained in the test tray T are tested by an outside tester (not shown). In the third chamber 154, tested packaged chips contained in the test tray T are cooled down or heated up to room temperature.

In the first embodiment, two test sites 153 are provided in the second chamber 152. Each of test boards 170 of the outside tester gets in contact with each of the test site 153. Each test board 170 has a plurality of sockets. The sockets are electrically connected to the outside tester.

The test boards 170 are placed in the upright position, to contact the test site 153 provided in the rear of the handler.

A pushing unit 165 for pushing the test tray T toward the test board, is provided to the second chamber 152. The pushing unit 165 applies pressure to the test tray T to push the test tray T against the test site 153, thereby inserting the packaged chips into the sockets of the test board, respectively. The pushing unit 165 can move the test tray T backwards and forwards.

Two rotators 160 are provided in front of the test unit 150. In the exchanging site 130, the rotator 160 rotates the horizontally-positioned test tray T to place it in the upright position. The rotator 160 rotates the upright-positioned test tray T, which is transferred from the test unit 150, to place it in the horizontal position.

The first and third chambers 151 and 154 are positioned in a vertical line with the second chamber in between. As shown in FIG. 2, the first chamber 151 may be positioned over the second chamber 152, but the third chamber 154 under the second chamber 152. Otherwise, the third chamber 154 may be positioned over the second chamber 152, but the first chamber 151 under the second chamber 152.

In a case where the exchanging site 130 is provided in front of the second chamber 152, a first driving unit (not shown) is provided to the test unit 150. The first driving unit moves upwards the upright-positioned test tray T in a pair to transfer the test trays T into the first chamber 151. And a second driving unit (not shown) is provided to the test unit 150. The second driving unit moves forwards the upright-positioned test units in a pair in the first chamber 151, maintaining a given distance between the proceeding and following pairs of upright-positioned test trays T.

A third driving unit is provided to the test unit 150. The third driving unit moves downwards the upright-positioned test trays T in a pair from the first chamber 151 through the second chamber 152 to the third chamber 154. A fourth driving unit is provided to the test unit 150. The fourth driving unit moves forwards the upright-positioned test trays T in a pair in the third chamber 154, maintaining a given distance between the proceeding and following pairs of upright-positioned test trays T. A fifth driving unit is provided to the test unit 150. The fifth driving unit moves upwards the upright-positioned test trays T in a pair from the third chamber 154 to transfer the test trays T back to the exchanging site 130.

The method for transferring test trays according to the first embodiment of the present invention is now described, provided that the handler with the above-described configuration has the test unit 150 which is configured as shown in FIG. 2.

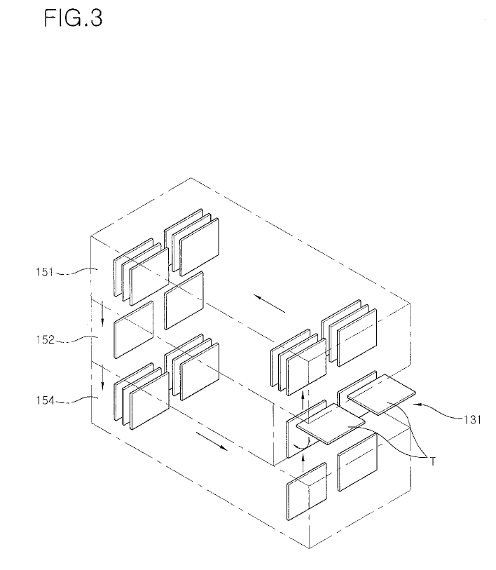

As shown in FIG. 3, the test trays T, each containing to-be-tested packaged chips, are placed in a pair at a waiting location 131 in front of the second chamber 152. The waiting location 131 may correspond to the exchanging site 130. The test trays T wait in a pair at the waiting location 131, each being in the horizontal position.

The test trays T, after each is rotated to be in the upright position, are transferred in a pair into the first chamber 151.

In a case where the first chamber 151 is divided into two sections, two test trays T are transferred into the two sections of the first chamber 151, respectively. Thereafter, next test trays T are placed in a pair at the waiting location 131, and transferred into the two sections of the first chamber 151, respectively.

All of this enables the test trays T to be successively transferred in a pair into the first chamber 151. The successive in-a-pair transfer of the test trays T is more efficient in performing the test than the one-by-one transfer of the test tray T.

The two test trays T may move a given distance horizontally from the waiting location 131 toward the second chamber 152 before rotating the two trays T to be in the upright position.

The test tray T may be rotated to be in the upright position at a certain position which is as close as possible to the waiting location 131 to speed up transfer of the test tray T. After the test tray T is rotated to be in the upright position, the test tray T may be moved upwards to be transferred into the first chamber 151.

The upright-positioned test trays T, after introduced into the first chamber 151, are moved forwards in a pair in the first chamber 151. At this point, a given distance is maintained between the proceeding and following pairs of upright-positioned test trays T.

After the upright-positioned test trays T reach a certain position over the test site 153 as shown in FIG. 2, they are moved downwards in a pair into the second chamber 152. That is, the upright-positioned test trays T are moved downwards in a pair toward the test sites 153 (refer to FIG. 2) which are located just in a pair under the upright-positioned test trays T, to make the test trays T placed at the test sites, respectively. Then the packaged chips contained in both upright-positioned test trays T in a pair are inserted into the sockets of both test sites 153, respectively. Thereafter, the packaged chips are tested by the outside tester.

This enables all packaged chips contained in the two test trays T to be tested at the same time, thus increasing a quantity of packaged chips which are tested in a given time.

It is desirable to shorten the time for transferring the test tray T in transferring the test tray T into the second chamber 152. This can be done by moving downwards the upright-positioned test trays T from the first chamber 151 to the second chamber 152 without any delay. Thus, the upright-positioned test trays T are made to be placed close to the test sites 153, respectively.

After the packaged chips are tested in the second chamber 152, the upright-positioned test trays T are transferred into the third chamber 154. The upright-positioned test trays T are moved downwards from the second chamber 152 to the third chamber 154 without any delay to shorten the time for transferring the test tray.

The first, second, and third chambers may be arranged in the vertical line, for the upright-positioned test trays T to be in free fall from the first chamber 151 to the second chamber 152 and from the second chamber 152 to the third chamber 154.

The upright-positioned test trays T, after introduced into the third chamber 154, are moved forwards in a pair in the third chamber 153. At this point, a given distance is maintained between the proceeding and following pairs of test trays T.

When the upright-positioned test trays T reach a certain position where is under the waiting location 131, they are moved upwards in a pair to the waiting location 131. Then the upright-positioned test trays T are rotated to be in the horizontal position and then wait at the waiting location 131.

The upright-positioned test trays T are moved upwards, as they are, to the waiting location 131 after they go through the third chamber. If the test trays T are rotated to be in the horizontal position after going through the third chamber and are then moved upwards to the waiting location 131, the fifth driving unit is required to be more complex in structure to move upwards the horizontally-positioned test trays T. However, when the upright-positioned test trays T are upwards as they are, it is possible to simplify the structure of the fifth driving unit for moving upwards the test trays T from the third chamber 154 to the waiting location 131 and to speed up transfer of the test trays T from the third chamber 154 to the waiting location 131.

After the test trays T are transferred back to the waiting location 131, the packaged chips contained in the test trays T are transferred by the unloading picker to the unloading stacker 120. The user trays, each having the identification mark indicating the grade of packaged chip to be contained, are placed in the unloading stacker 120 to accordingly contain the tested packaged chips which are sorted according to grade.

After the tested packaged chips are all unloaded from the test tray T, new packaged chips are loaded by the loading picker onto the test tray T. That is, the to-be-tested and tested packaged chips are loaded onto and from the test tray T at the same time. The test tray T, after containing the new packaged chips, is transferred as above described.

In-a-pair transfer of the test trays T increases a quantity of packaged chips which are tested at a time and in a given time, compared with one-by-one transfer of the test tray T. It is because the packaged chips contained in the two test tray T are tested at the same time.

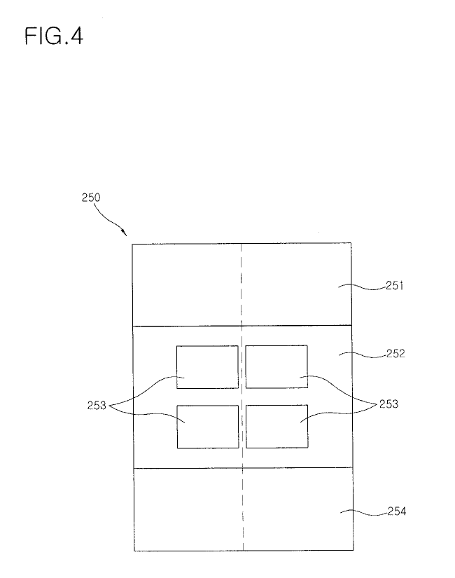

FIG. 4 illustrates a rear view of another test unit which is shown in FIG. 1. As shown in FIG. 4, four test sites are provided to a second chamber 252, which is provided to a test unit 250. The four test sites 253 are arranged in two rows and two columns.

A first chamber 251 is positioned over the second chamber 252 and a third chamber 254 is positioned under the second chamber 252. A method for transferring test trays according to a second embodiment of the present invention is now described. What differentiates the second embodiment from the first embodiment is described to avoid repetitive description.

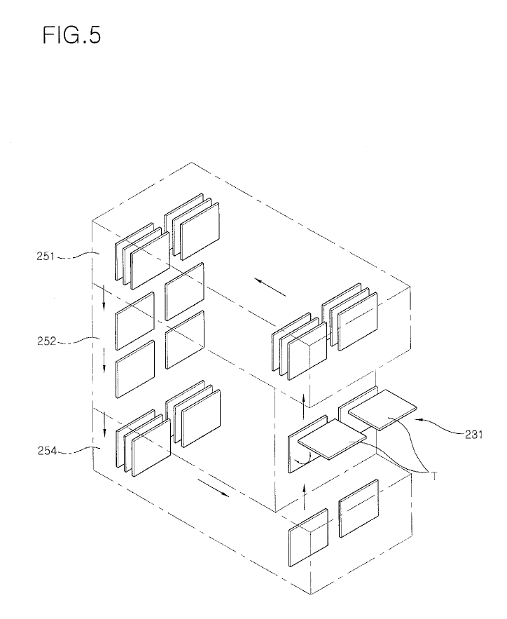

A plurality of test trays T are placed in a waiting location 231. As shown in FIG. 5, the test trays T are placed in a pair at the waiting location 231. To-be-tested packaged chips are loaded by a loading picker onto the test tray T. The test trays T, each containing the to-be-tested packaged chips are in a pair rotated to be in the uptight position by a rotator. Then upright-positioned test trays T are transferred in a pair into the first chamber 251 and are moved in a pair forwards in the first chamber 251.

The upright-positioned test trays T, when each reaching a certain place over the test site 253, are moved downwards in a pair into the second chamber 252. At this point, four upright-positioned test trays T are in pairs moved downwards to be placed at the four test sites 253, respectively, as shown FIG. 4.

Then the packaged chips contained in the four upright-positioned test trays T are inserted into the sockets of four test board docked to the four test sites 253, respectively, and are tested by an outside tester.

Like this, the method for transferring test trays according to the second embodiment of the present invention is available for the test unit equipped with the four test sites. The packaged chips contained in the four test tray T are tested at the same time. Thus, a quantity of the packaged chips which are tested at a time and in a given time are increased compared with the first embodiment.

The upright-positioned test trays T, after the packaged chips are tested in the second chamber, are transferred in a pair into the third chamber 254. The upright-positioned test trays T are moved forward in a pair in the third chamber 254.

After the upright-positioned test trays T reach a certain place under the waiting location 231, the upright-positioned test trays T are in a pair moved upwards. The upright-positioned test tray T is rotated to be in the horizontal position at the waiting location 231.

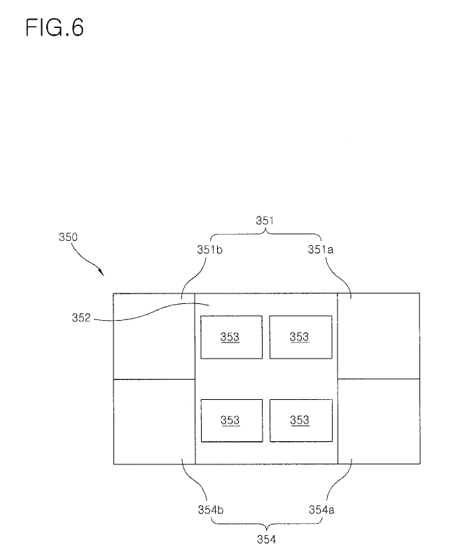

FIG. 6 illustrates a rear view of another test unit which is shown in FIG. 1. As shown in FIG. 6, four test sites 353 are provided to a second chamber 352. The four test sites are arranged in two rows and two columns.

A first chamber 351 includes a left first chamber 351a and a right first chamber 352b. The left and right first chambers 351a and 352b are arranged in parallel, with a second chamber 352 in between. That is, the left first chamber 351a is positioned on the left of the second chamber and the right first chamber 351b is positioned on the right of the second chamber 352.

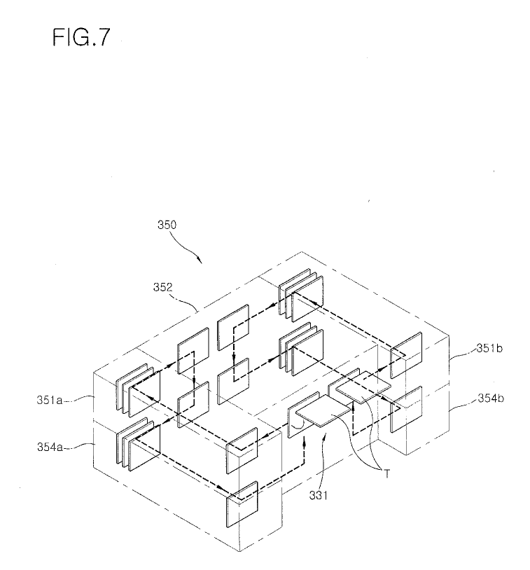

A third chamber 354 is arranged under the first chamber 351. The third chamber 354 includes a left third chamber 351a and a right third chamber 351b. The left third chamber 354a is arranged to be under the left first chamber 351a and the right third chamber 354b is arranged to be under the right first chamber 351a. Referring to FIG. 7, a method for transferring test trays according to a third embodiment of the present invention is now described. What differentiates the third embodiment from the first embodiment is described to avoid repetitive description.

As shown in FIG. 7, test trays T, each containing to-be-tested packaged chips are in a pair rotated to be in the upright position at a waiting location 331. One upright-positioned test tray T is transferred into the left first chamber 351a and the other into the right first chamber 351b. The two upright-positioned test trays T are moved forwards in the left and right first chambers 351a and 351b, respectively.

The two upright-positioned test trays T go through the left and right first chambers 351 a and b, respectively. Then the two upright-positioned test trays T from the left and right first chambers 351 a and b are in a pair transferred into the second chamber 352 horizontally. The two upright-positioned test trays T, after introduced into the second chamber 352, are in a pair moved downwards. Subsequently, another two upright-positioned test trays T from the left and right first chambers 351 a and 351b first are transferred into the second chamber 352. When all of this is done, the four upright-positioned test trays T in two rows and two columns are placed at the four test sites in two rows and two columns, respectively.

Then a pushing unit in the second chamber 352 pushes the upright-positioned test trays T in two rows and two columns toward an outside tester to insert the packaged chips into sockets of test boards in rows and columns for an electrical test.

Like this, the method for transferring test trays according to the third embodiment of the present invention is available for the test unit equipped with the four test sites. The packaged chips contained in the upright-positioned four test tray T are tested at the same time. Thus, a quantity of the packaged chips which are tested at a time and in a given time are increased compared with the first embodiment.

After testing, a lower pair of the upright-positioned test trays T are moved horizontally into the left and right third chambers 354a and 354b, respectively. And a upper pair of the upright-positioned test trays T are moved downwards into the left and right third chambers 354a and 354b, respectively.

The tested packaged chips contained in the upright-positioned test trays T are cooled or heated to room temperature, while the upright-positioned test trays T are moved forwards in the left and right third chambers 354a and 354b, respectively.

After each reaching the ends of the left and right third chamber 354a and 354b, the upright-positioned test trays T turn to the right and to the left, respectively to go towards under the waiting location 331. The upright-positioned test trays T, when under the waiting location 331, are moved upwards to return to the waiting location 331.

The upright-positioned test tray T is rotated to be in the horizontal position at the waiting location 331. The upright-positioned test trays T may be in a pair rotated to be in the horizontal position at the waiting location 331.

The left and right third chamber 354a and 354b may be provided over the left and right first chamber 351a and 351b (This is not shown).

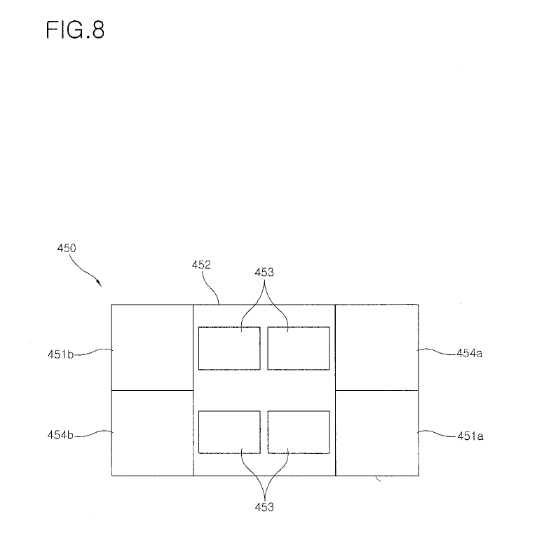

FIG. 8 illustrates a rear view of another test unit which is shown in FIG. 1. As shown in FIG. 8, four test sites 453 are provided to a test unit 450. The four test sites are arranged in two rows and two columns.

A first chamber 451 includes a left first chamber 451a and a right first chamber 451b. The left and right first chamber 451a and 451b are arranged to be diagonally opposite to each other, with the second chamber 452 in between. A third chamber 454 includes a left third chamber 454a and a right third chamber 454b. The left and right first chamber 454a and 454b are arranged to be diagonally opposite to each other, with the second chamber 452 in between.

A method for transferring test trays according to a fourth embodiment of the present invention is now described. The method for transferring test trays according to the fourth embodiment of the present invention is used when the left first chamber 451a is provided under the left third chamber 454a and the right first chamber 451b over the right third chamber 454b. What differentiates the fourth embodiment from the first embodiment is described to avoid repetitive description.

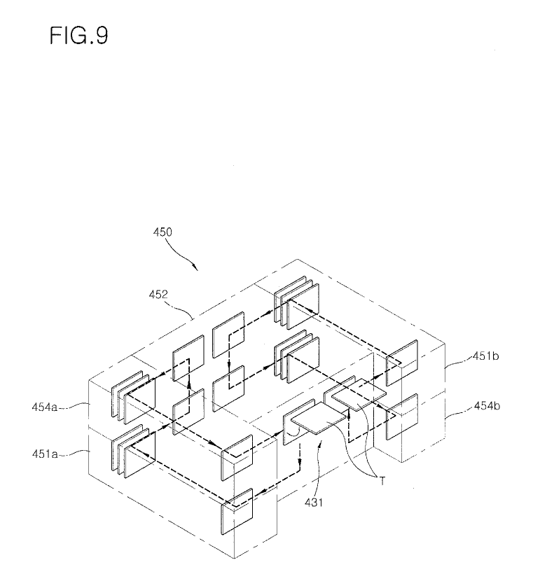

As shown in FIG. 9, two test trays T, each containing to-be-contained packaged chips, are in a pair placed at a waiting location 431, horizontally parallel to each other. The two test trays T are in a pair rotated to be in the upright position.

The left test tray T and the right test tray T are transferred into the left first chamber 451a and the right first chamber 451b, respectively.

That is, the left test tray T, after rotated to be in the upright position, is moved downwards and then moved horizontally into the left first chamber 451a. The right test tray T is moved horizontally into the right first chamber 451b.

The height of the right first chamber 451b and the left third chamber 454a is the same as that of the waiting location 431, to shorten the distance which the test tray T has to move.

The upright-positioned test trays T, after introduced into the left and right first chambers 451a and 451b, are horizontally moved in the left and right chambers 451a and 451b, respectively. The upright-positioned test trays T are moved toward the test chamber 452, respectively, after reaching the ends of the left and right first chambers 451a and 451b, respectively.

The handler according to the present invention includes the test sites 453 which is arranged in two rows and two columns. Four test trays T are transferred to the test unit to match the four test sites 453. That is, one upright-positioned test tray T, after introduced into the test chamber 452 from the left first chamber 451a, is placed at a upper left test site and the following upright-positioned test tray T is placed at a lower left test site.

The other upright-positioned test tray T, after introduced into the test chamber 452 from the right first chamber 451b, is placed at a lower right site and the following upright-positioned test tray T is placed at a upper right site. In this way, the four t upright-positioned test trays T are placed in the test chamber 452.

Subsequently, the four upright-positioned test trays T are all pushed at a time by a pushing unit (not shown) toward the test unit to perform the electrical test on the packaged chips

The four test trays T, after testing, are moved from the test chamber 452 to the third chamber 454

According to the fourth embodiment of the present invention, one upright-positioned test tray T in the test chamber 452 which is provided close to the left third chamber 454a is moved into the left third chamber 454a. The other upright-positioned test tray T in the test chamber 452 which is provided close to the right third chamber 454b is moved into the right third chamber 454b.

As shown in FIG. 9, the upright-positioned test tray T placed at the upper left site 453 is horizontally moved into the left third chamber 454a. The following upright-positioned test tray T placed at the lower left site 453 is moved upwards to the upper left site and horizontally moved into the left third chamber 454a.

The upright-positioned test tray T placed at the lower right site 453 is horizontally moved into the light third chamber 454b. The following upright-positioned test tray T placed at the upper right site 453 is moved downwards to the lower right site 453 and horizontally moved into the right third chamber 454b.

The upright-positioned test trays T are cooled or heated to room temperature while they are moved forward in the left and right third chambers 454a and 454b, respectively. The upright-positioned test trays T return to the waiting location 431, after reaching the ends of the left and right third chamber 454a and 454b, respectively.

That is, the upright-positioned test tray T in the left third chamber 454a is horizontally moved to the waiting location 431. And the upright-positioned test tray T in the right third chamber 454b is horizontally moved and then moved upwards to the waiting location 431.

The upright-positioned test trays T, returning from the left and right third chamber 454a and 454b, are rotated to be in the horizontal position at the waiting location 431.

An unloading picker sorts the tested packaged chip according to grade, when the test tray T is in the horizontal position.

At the waiting location 431, the tested packaged chips are unloaded from the test tray T and the to-be-tested packaged chips are loaded onto the test tray T. The test tray T containing the to-be-tested packaged chips goes through the first, second, and third chambers 451, 452 and 454 as above described, to perform the test on the to-be-tested packaged chips.

According to the fourth embodiment of the present invention, the first chamber and third chamber are provided adjacent to each of the left and right sides of the second chamber. This enables the left or right section of the handler to operate independently of each other. In case of testing a small amount of packaged chips, such as re-testing, operation of one section of the hander is cost-effective, compared with operation of the whole handler.

A rotating unit in the waiting location and a pushing unit in the test chamber are individually geared to operate the left or right section of the handler.

A method for transferring test trays according to a fifth embodiment of the present invention is now described. The method for transferring test trays according to the fifth embodiment of the present invention is used when a test unit is configured as shown in FIG. 8. What differentiates the fifth embodiment from the fourth embodiment is described to avoid repetitive description.

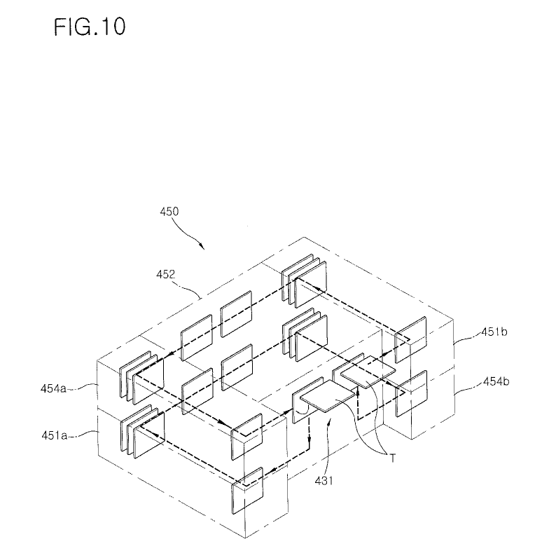

As shown in FIG. 10, each of loading pickers loads a to-be-tested packaged chip onto each of test trays T which are arranged in a pair and in parallel at a waiting location 431. Then the test tray is rotated to be in the upright position.

A first chamber 450 includes a left first chamber 451a and a right first chamber 452b. The upright-positioned test trays T, each containing the to-be-tested packaged chips, are moved into the left and right first chamber 451a and 451b, respectively. The upright-positioned test trays T are horizontally moved in the left and right first chamber 451a and 451b, respectively. The upright-positioned test trays T are moved from a waiting location 431 into the left and right first chamber 451a and 451b in the same manner as the upright-positioned test trays T in the fourth embodiment. The upright-positioned test trays T are moved in the left and right first chamber 451a and 451b in the same manner as the upright-positioned test trays T in the fourth embodiment.

The upright-positioned test trays T are moved horizontally into the second chamber 452 after they reach the ends of the left and right first chamber 451a and 451b, respectively. It is horizontally that the upright-positioned test trays T are moved from the left and right first chamber 451a and 451b moved to test sites, respectively.

In the fifth embodiment, a driving unit is not necessary which moves upwards the upright-positioned test trays T from the second chamber 452, because the upright-positioned test trays T are moved only horizontally.

Four upright-positioned test trays T in two rows and two columns are in a pair placed at four test sites in two rows and two columns, respectively. The four upright-positioned test trays T are pushed all or individually by a pushing unit (not shown) toward an outside tester to insert the packaged chips into sockets of four test boards in two rows and two columns, respectively, to perform the electrical test on the packaged chips.

The upright-positioned test trays T, after the packaged chips are tested, are moved into the third chamber.

In the fifth embodiment, the upright-positioned test tray T placed at the lower site 453 is moved into the right third chamber 454b and the upright-positioned test tray T placed at the upper site 453 is moved into the left third chamber 454a.

The upright-positioned test trays T are cooled or heated to room temperature while they are horizontally moved in the left and right third chambers 454a and 454b, respectively.

Subsequently, the upright-positioned test trays T returns to the waiting location 431 after each reaching the ends of the left and right third chambers 454a and 454b.

As shown in FIG. 10 the test tray T which was positioned on the left of the waiting location 431, returns to the right of the waiting location 431 after going through the second chamber 452. And the upright-positioned test tray T which was positioned on the right of the waiting location 431, returns to the left of the waiting location 431 after going through the second chamber 452. Then the upright-positioned test trays T, which are placed at the left and right sides of the waiting location 451, respectively, are rotated to be in the horizontal position. At the waiting location 451, new packaged chips are loaded onto the test tray T by the loading picker. And the tested packaged chips are unloaded from the test tray T by the unloading picker. The tested packaged are sorted according to grade and contained in the corresponding user trays.

That is, a set of the loading picker and unloading picker unloads the tested packaged chips and loads new packaged chips from and onto the test tray T, which has returned to the right side of the waiting location 451. Another set of the loading picker and unloading picker unloads the tested packaged chips and loads new packaged chips from and onto the test tray T, which has returned to the left side of the waiting location 451.

It is more effective in transfer of test trays to perform loading and unloading operations on one test tray T at the same time.

It is impossible to load new packaged chips onto the test tray T at the left side of the waiting location 451 and at the same time to unload the tested packaged chips form the test tray T at the right side of the waiting location 451. It is because the test tray T which started from the right side of the waiting location 451 returns to the left side of the waiting location 451. Therefore, the tested packed chips have to be unloaded from the test tray T and at the same time new packaged chips have to be loaded onto the same test tray T.

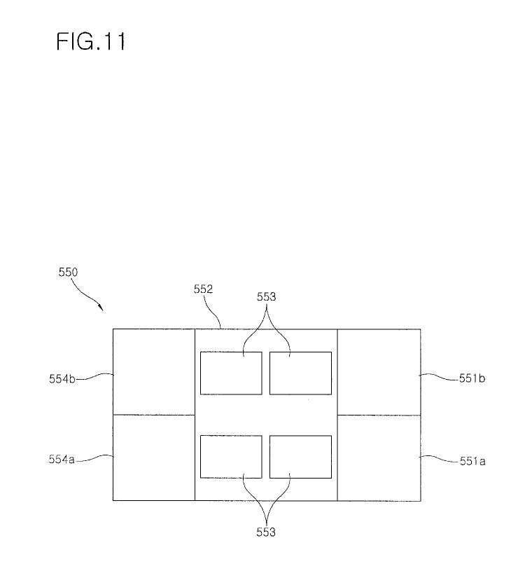

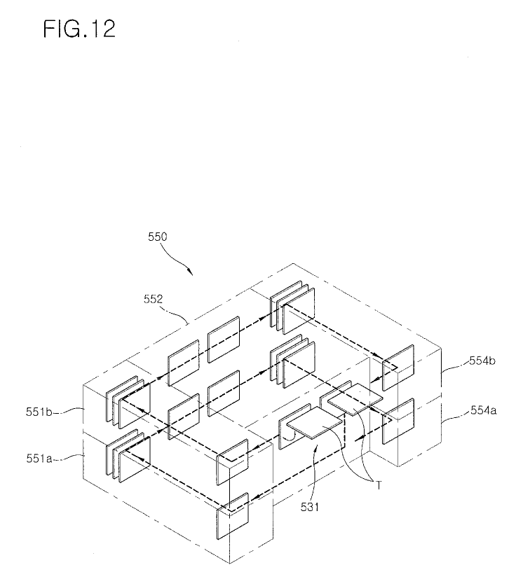

A method for transferring test trays according to a sixth embodiment of the present invention is now described. The method for transferring test trays according to the sixth embodiment of the present invention is used when test sites are arranged in two tows and two columns as shown in FIGS. 11 and 12. What differentiates the sixth embodiment from the fourth embodiment is described to avoid repetitive description.

A first chamber includes a lower first chamber 551a and a upper first chamber 551b. A third chamber includes a lower third chamber 554a and a upper third chamber 554b.

According to the sixth embodiment of the present invention, the lower and upper first chamber 551a and 551b are provided to the left of the handler. And the lower and upper third chamber 554a and 554b are provided to the right of the handler.

The lower and upper first chamber 551a and 551b may be combined into a single first chamber 551, which provides two passages along which two test trays T are moved independently of each other. The lower and upper third chamber 554a and 554b may be combined into a single third chamber 554, which provides two passages along which two test trays T are moved independently of each other.

As shown in FIG. 10, each of loading pickers loads a to-be-tested packaged chip onto each of test trays T which are arranged in a pair and in parallel at a waiting location 531. After a loading picker loads the to-be-tested packaged chips onto the test trays T, the test trays T are in a pair rotated to be in the upright position.

As shown in FIG. 12, the upright-positioned test tray T at the left side of the waiting location 531 is horizontally moved into the upper first chamber 551b. And the upright-positioned test tray T at the right side of the waiting location 531 is moved downwards and horizontally moved into the lower first chamber 551a which is provided under the upper first chamber 551b.

The upright-positioned test trays T are cooled or heated to room temperature wile they are moved forward in the lower and upper first chamber 551a and 551b, respectively. The upright-positioned test trays T are horizontally moved toward a second chamber from the lower and upper first chamber 551a and 551b, respectively, after each reaching the ends of the second chamber 552. That is, the upright-positioned test tray T in the upper first chamber 551b is moved to an upper test site and the upright-positioned test T in the lower first chamber 551a is moved to an lower test site. In this way, the upright-positioned four test trays T in two rows and two columns are placed at the four test sites in two rows and two columns, respectively.

The packaged chips are tested as in the above-described embodiments.

The upright-positioned test trays T, after the packaged chips are all tested, are horizontally moved into the lower and upper third chambers 554a and 554b, respectively, which are provided on the right side of the handler.

Then the upright-positioned test trays T are moved forwards and reach the ends of the lower and upper third chambers 554a and 554b, respectively.

The upright-positioned test trays T return to the waiting location 531 after each reaching the ends of the lower and upper third chamber 554a and 554b. That is, the upright-positioned test tray T in the upper third chamber 554b is horizontally moved and returns to the left side of the waiting location 531. The upright-positioned test tray T in the lower third chamber 554a is horizontally moved, moved upwards and returns to the right side of the waiting location 531. The upright-positioned test trays T are rotated to be in the horizontal position at the waiting location 531.

In the sixth embodiment, the test trays T are moved horizontally in the second chamber 552, Thus, a driving unit for moving the test tray T is made simple in structure.

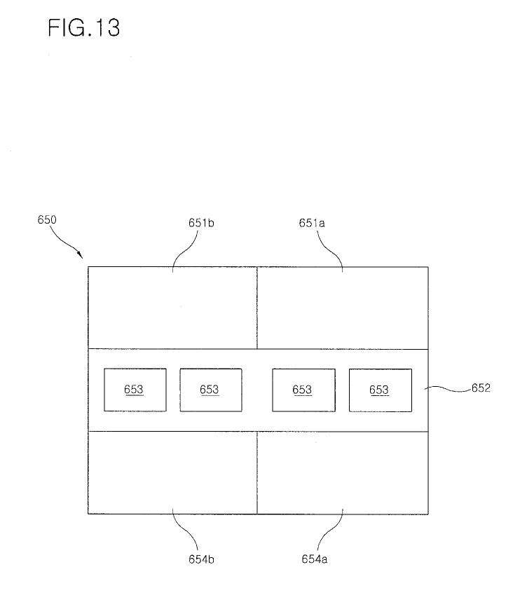

FIG. 13 illustrates a rear view of another test unit which is shown in FIG. 1. As shown in FIG. 13, four test sites 653 are provided to a second chamber 652 provided to a test unit 650. The four test sites are arranged in one row.

A first chamber 651 includes a left first chamber 651a and a right first chamber 651b. A third chamber 654 includes a left third chamber 654a and a right third chamber 654b. The left and right first chamber 651a and 651b are provided over a second chamber 652. The left and right third chamber 654a and 654b are provided under the second chamber 652.

A plurality of passages, along which a pair of test trays T are horizontally moved, are provided in each of the left and right first chamber 651a and 651b. A plurality of passages, along which a pair of test trays T are horizontally moved, are provided in each of the left and right third chamber 654a and 654b.

The left and right first chamber 651a and 651b may be combined into a single first chamber 651 which are divided into two sections using a partition.

A method for transferring test trays according to a seventh embodiment of the present is now described. What differentiates the seventh embodiment from the above-described embodiments is described to avoid repetitive description.

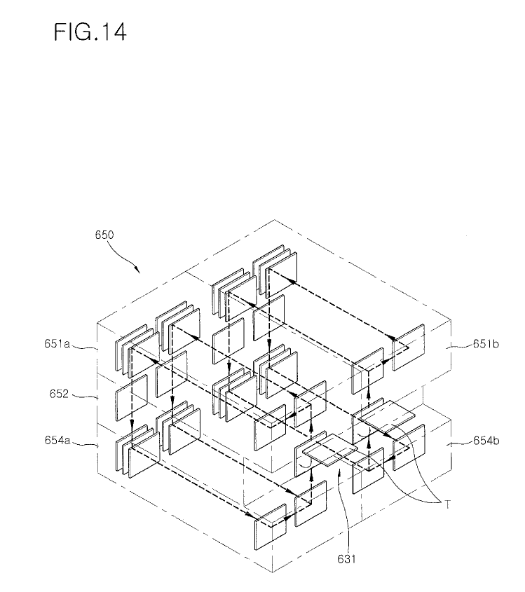

As shown in FIG. 14, each of loading pickers loads a to-be-tested packaged chip onto each of test trays T which are arranged in a pair and in parallel at a waiting location 431. After a loading picker loads the to-be-tested packaged chips onto the test trays T, the test trays T are in a pair rotated to be in the upright position. Then the upright-positioned test trays T are moved upwards into the left and right first chamber 651a and 651b, respectively.

The left and right first chamber 651a and 651b has slots, respectively. Through these slots, the upright-positioned test trays T are moved from the waiting location 631 into the left and right first chamber 651a and 651b, respectively.

The upright-positioned test tray T introduced into the left first chamber 651a is horizontally moved. The next upright-positioned test tray T are introduced into the left first chamber 651a. Thus, a pair of upright-positioned test trays T are placed in parallel to each other in the left first chamber 651a. In the same manner, a pair of upright-positioned test trays T are placed in parallel to each other in the right first chamber 651b.

The pairs of upright-positioned test trays T are horizontally moved into the left and right first chamber 651a and 651b, respectively. Thus, total four upright-positioned test trays T are placed in the left and right first chambers 651a and 651b, at the same time.

The pairs of upright-positioned test trays T are moved downwards into the second chamber 652, after reaching the ends of the left and right first chamber 651a and 651b, respectively.

Thus, the four upright-positioned test trays T are placed in a row in the second chamber 652. The four upright-positioned test trays T in a row are pushed by a pushing unit toward an outside tester to test the packaged chips contained in the four upright-positioned test trays T.

The pairs of upright-positioned test trays T, after the packaged chips are tested, are moved downwards into the left and right third chamber 654a and 654b, respectively.

The pairs of upright-positioned test trays T are cooled or heated to room temperature while they are moved forwards in the left and right third chamber 654a and 654b, respectively.

The upright-positioned test trays T are moved upwards toward the waiting location 631 after each reaching the ends of the left and right third chamber 654a and 654b. The upright-positioned test trays T are rotated to be in the horizontal position at the waiting location 631.

The left and right third chambers 654a and 654b has slots, respectively. Through the slots, the upright-positioned test trays T are one by one moved upwards from the left and right third chamber 654a and 654b to the waiting location 631, respectively

Each of the first and third chambers has only one slot to keep each chamber as airtight as possible. This makes it easy to control temperature in the first and third chambers.

When the upright-positioned test tray T returns to the waiting location 631, the upright-positioned test tray T is rotated to be in the horizontal position. The unloading picker unloads the tested packaged chip from the test tray T and the loading picker loads new packaged chips onto the test tray T. The tested packaged chips are sorted and contained in the corresponding user trays according to grade.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A method for transferring test trays in a handler comprising a second chamber having two test sites arranged in parallel, a first chamber having a plurality of passages along which a plurality of test trays are horizontally moved, provided over the second chamber, and a third chamber having a plurality of passages along which the plurality of test trays are horizontally moved, provided under the second chamber, the method comprising steps of:
(a) enabling two test trays to wait in parallel in a horizontal position at a waiting location provided to a forward section of the handler;
(b) loading packaged chips onto the two test trays;
(c) rotating the two test trays to be in the upright position;
(d) moving upwards the two test trays into the first chamber;
(e) heating or cooling the two test trays while moving horizontally the two test trays forward in the first chamber;
(f) moving downward the two test trays from the first chamber into the second chamber;
(g) moving horizontally the two test trays toward two test boards connected to the second chamber, the two test boards opposite to the handler and thus enabling the two test trays to contact the two test boards to test the packaged chips contained the two test trays.
(h) moving downwards the two test trays from the second chamber into the third chamber and allowing the two test trays to be cooled or heated to room temperature while moving forwards the two test trays in the third chamber;
(i) moving upwards the two test trays from the third chamber to the waiting location;
(j) rotating the two test trays to be in the horizontal position; and
(k) unloading the packaged chips from the two test trays.

2. The method according to claim 1, wherein the two test trays are moved at the same time in a pair.

3. The method according to claim 1, further comprising a step of enabling the two test trays to move a given distance horizontally from the waiting location toward the second chamber before rotating the two test trays to be in the upright position.

4. The method according to claim 1, wherein in the step (k) the packaged chips are unloaded from the two test trays onto which new packaged chips are loaded at the same time.

5. A method for transferring test trays in a handler comprising a second chamber having two test sites arranged in parallel, a first chamber having a plurality of passages along which a plurality of test trays are horizontally moved, provided under the second chamber, and a third chamber having a plurality of passages along which the plurality of test trays are horizontally moved, provided over the second chamber, the method comprising steps of:
(a) enabling two test trays to wait in parallel in a horizontal position at a waiting location provided to a forward section of the handler;
(b) loading packaged chips onto the two test trays;
(c) rotating the two test trays to be in the upright position;
(d) moving downwards the two test trays into the first chamber;
(e) heating or cooling the two test trays while moving horizontally the two test trays forward in the first chamber;
(f) moving upwards two test trays from the first chamber into the second chamber;
(g) moving horizontally the two test trays toward two test boards provided in the second chamber, the two of test boards opposite to the handler and thus enabling the two test trays to contact the two test boards to test the packaged chips contained the two test trays.
(h) moving upwards the two test trays from the second chamber into the third chamber, and allowing the two test trays to be cooled or heated to room temperature while moving forwards the two test trays in the third chamber;
(i) moving downwards the two test trays from the third chamber to the waiting location;
(j) rotating the two test trays to be in the horizontal position; and
(k) unloading the packaged chips from the two test trays.

6. A method for transferring test trays in a handler comprising a second chamber having four test sites arranged in two rows and two columns, a first chamber having a plurality of passages along which a plurality of test trays are horizontally moved, provided over the second chamber, and a third chamber having a plurality of passages along which the plurality of test trays are horizontally moved, provided under the second chamber, the method comprising steps of:
(a) enabling two test trays to wait in parallel in a horizontal position at a waiting location provided to a forward section of the handler;
(b) loading packaged chips onto the two test trays;
(c) rotating the two test trays to be in the upright position;
(d) moving upwards the two test trays into the first chamber;
(e) heating or cooling the two test trays while moving horizontally the two test trays forward in the first chamber;
(f) moving downwards the two test trays from the first chamber and placing the two test trays at the lower two test sites of the second chamber;
(g) moving downwards the next test trays from the first chamber and placing the two trays at the upper two test sites of the second chamber,
(h) moving horizontally the four test trays toward four test boards provided in the second chamber, the four test boards opposite to the handler and thus enabling the four test trays to contact the four test boards to test the packaged chips contained the four test trays.
(i) moving downwards the two test trays from the second chamber into the third chamber, and allowing the two test trays to be cooled or heated to room temperature while moving forwards the two test trays in the third chamber;
(j) moving upwards the two test trays from the third chamber to the waiting location;
(k) rotating the two test trays to be in the horizontal position; and
(l) unloading the packaged chips from the two test trays.

7. A method for transferring test trays in a handler comprising a second chamber having four test sites arranged in a row, a first chamber having a plurality of passages along which a plurality of test trays are horizontally moved, provided over the second chamber, and a third chamber having a plurality of passages along which the plurality of test trays are horizontally moved, provided under the second chamber, the method comprising steps of:
(a) enabling two test trays to wait in parallel in a horizontal position at a waiting location provided to a forward section of the handler;
(b) loading packaged chips onto the two test trays;
(c) rotating the two test trays to be in the upright position;
(d) moving upwards the two test trays into the first chamber;
(e) moving horizontally the two test trays and moving upwards the next two test trays into the first chamber, resulting in the four test trays being placed in a row;
(f) heating or cooling the four test trays while moving horizontally the four test trays forward in the first chamber;
(g) moving downwards the four test trays from the first chamber into the test chamber;
(h) moving horizontally the four test trays toward four test boards provided in the second chamber, the four test boards opposite to the handler and thus enabling the four test trays to contact the four test boards to test the packaged chips contained the four test trays.
(i) moving downwards the four test trays from the second chamber into the third chamber, and allowing the four test trays to be cooled or heated to room temperature while moving forwards the four test trays in the third chamber;
(j) moving upwards the two test trays out of the four test trays from the third chamber to the waiting location;
(k) rotating the two test trays to be in the horizontal position;
(l) unloading the packaged chips from the two test trays.
(m) moving horizontally the remaining two test trays in the third chamber, moving upwards the remaining two test trays from the third chamber to the waiting location, and rotating the remaining two test trays to be in the horizontal position; and
(n) rotating the remaining two test trays to be in the horizontal position.

8. A method for transferring test trays in a handler comprising a second chamber having four test sites arranged in two rows and two columns, two first chambers, and two third chambers wherein one first chamber and one third chamber are arranged adjacent to one side of the second chamber and the other first chamber and the other third chamber are arranged adjacent to the other side of the second chamber, the method comprising steps of:
(a) enabling two test trays to wait in parallel in a horizontal position at a waiting location provided to a forward section of the handler;
(b) loading packaged chips onto the two test trays;
(c) rotating the two test trays to be in the upright position;
(d) moving the two test trays from the waiting location into the first chambers, respectively;
(e) moving horizontally the two test trays forwards in the first chambers, respectively;
(f) moving the four test trays in pairs from the first chambers into the second chamber having four test sites arranged in two rows and two columns;
(g) moving horizontally the four test trays placed at the four sites toward four test board opposite to the handler;
(h) moving the four test trays from the second chamber into the third chambers and cooling or heating the four test trays to room temperature while moving horizontally the four test trays forward in the third chambers;
(i) moving the two test trays, one from each of the third chambers, from the third chambers to the waiting location;
(j) rotating the two test trays to be in the upright position at the waiting location; and
(k) unloading the packaged chips from the two test trays.

9. The method according to claim 8, wherein the two first chambers comprise a left first chamber provided to the left of the second chamber and a right first chamber provided to the right of the second chamber, and the two third chambers comprise a left third chamber provided under the left first chamber and a right third chamber provided under the right first chamber.

10. The method according to claim 9, wherein in the step (f) the two test trays are moved horizontally from the left and right first chambers, respectively, into the second chamber and moved downwards to be placed at the lower test sites, and the next two test trays are moved horizontally from the left and right chambers, respectively, into the second chamber and moved to be placed at the upper test sites.

11. The method according to claim 9, wherein in the step (i), the two test trays are moved horizontally from the left and right third chambers, respectively, and moved upwards to the waiting location.

12. The method according to claim 8, wherein the first chamber comprises a left first chamber provided adjacent to the left of the second chamber and a right first chamber provided adjacent to the right of the second chamber, and the third chamber comprises a left third chamber provided over the left first chamber and a right third chamber provided under the right first chamber.

13. The method according to claim 12, wherein the step (f) comprises steps of:
moving horizontally the two test trays, one from the left first chamber and the other from the right first chambers, and moving upwards the test tray coming from the left first chamber and moving downwards the test trays coming from the right first chamber; and
moving horizontally the two test trays to the second chamber, one from the left first chamber and the other from the right first chamber.

14. The method according to claim 12, wherein the step (f) comprises a step of moving horizontally the two test trays, one from the left first chamber and the other from the right first chamber, into the second chamber and moving horizontally the two test trays from the left and right first chambers.

15. A method for transferring test trays in a handler comprising a second chamber having four test sites arranged in two rows and two columns, lower and upper first chambers, each being provided adjacent to one side of the second chamber, and lower and upper third chambers, each being provided adjacent to the other side of the second chamber, the method comprising steps of:
(a) enabling two test trays to wait in parallel in a horizontal position at a waiting location provided to a forward section of the handler;
(b) loading packaged chips onto the two test trays;
(c) rotating the two test trays to be in the upright position;
(d) moving horizontally the two test trays, respectively and moving the two test trays from the waiting location into the lower and upper first chambers, respectively;
(e) moving the two test trays forwards in the lower and upper first chambers, respectively;
(f) moving the four test trays in pairs and successively from the lower and upper first chamber into the second chamber having the four test sites arranged in two rows and two columns;
(g) moving the four test trays placed at the four test sites toward four test boards opposite to the handler;
(h) moving the four test trays from the second chamber into the lower and upper third chambers and cooling or heating the four test trays to room temperature while moving horizontally the four test trays forward in the lower and upper third chambers, respectively;
(i) moving the two test trays, one from the lower third chamber and the other from the upper third chamber to the waiting location;
(j) rotating the two test trays to be in the upright position at the waiting location; and
(k) unloading the packaged chips from the two test trays.

16. The method according to claim 15, wherein in the step (d), one test tray is horizontally moved and the other test tray is moved downwards and then is moved horizontally.

17. The method according to claim 15, wherein in the step (i), one test tray is horizontally moved from the lower third chamber to the waiting location, and the other test tray is horizontally moved from the upper third chamber and then is moved upwards.
